(19) United States
(12) Patent Application Publication
(10) Pub. No.: US 2015/0337881 A1
(43) Pub. Date: Nov. 26, 2015

(54) Tank Liner Clamp System

(71) Applicant: S & S Safety Clamp, LLC, Elgin, ND (US)

(72) Inventors: Seymour A. Volk, Elgin, ND (US); Benjamin J. Roth, Elgin, ND (US)

(73) Assignee: S & S Safety Clamp, LLC, Elgin, ND (US)

(21) Appl. No.: 14/282,525

(22) Filed: May 20, 2014

(51) Int. Cl. F16B 2/12; F16B 2/18; B65D 90/04

(52) U.S. Cl. CPC F16B 2/12; B65D 90/04; F16B 2/18

(57) ABSTRACT

A tank liner clamp system for efficiently securing a flexible tank liner within a containment tank. The tank liner clamp system generally includes a clamp unit, a first member and a second member slidably connected to the clamp unit, and a clamping handle having a cam pivotally connected to the clamp unit. The first member includes a biasing member to bias the first member inwardly towards the second member. The clamping handle is pivoted causing the cam to engage and inwardly force the second member towards the first member.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a tank liner clamp and more specifically it relates to a tank liner clamp system for efficiently securing a tank liner.

2. Description of the Related Art

Any discussion of the related art throughout the specification should in no way be considered as an admission that such related art is widely known or forms part of common general knowledge in the field.

Tank liners for containment tanks have been in use for years to store large volumes of liquids such as water and chemicals. The containment tanks are typically constructed of a portable structure to allow for movement from one work site to another. One example of a portable containment tank that utilizes a tank liner is a frac tank used in hydraulic fracturing (a.k.a. “fracking”) which is a process that uses highly pressured water and chemicals to coax oil and gas out of shale-rock formations. The water and chemicals must be temporarily stored near the drilling site and the usage of portable tanks is commonly used in the fracking industry. The portable tank includes at least one sidewall to form a perimeter wall (e.g. a circular wall) and then the tank liner is positioned on the interior of the portable tank with the end portions overlapping the upper end of the sidewall.

To secure the tank liner to the sidewall of the containment tank, two types of liner securing systems are used. The first type of liner securing system is comprised of an elongated liner clamp that is secured along the upper end of the sidewall with a plurality of fasteners such as that manufactured by WESTEEL in Winnepeg, Canada. The problem with elongated liner clamps that utilize fasteners is that they are time and labor consuming to install and uninstall. In addition, the elongated liner clamps require the usage of tools to secure and remove the threaded fasteners. In addition, the threaded fasteners may be come rusted over time making them difficult to remove or install. Also, aligning the threaded fasteners with the apertures in the sidewall of the tank can be difficult and time consuming.

The second type of liner securing system is comprised of a plurality of C-clamps (typically 2 or 3 C-clamps) attached to an inner bar member and an outer bar member. The inner bar member is positioned adjacent to the interior portion of the liner that is within the interior of the sidewall and the outer bar member is positioned adjacent to the exterior portion of the liner that is outside of the sidewall. The C-clamps are tightened causing the inner and outer bar members to secure the liner to the upper perimeter of the sidewall. While the C-clamp style does not require the usage of tools or aligning threaded fasteners with apertures, the C-clamps are still time and labor consuming because the user has to rotate the C-clamp until fully tightened. Another problem with C-clamps is that they become rusted over time making them difficult to remove and install. Another problem with C-clamps is that over time they may become loosened resulting in the liner falling into the tank. Another problem with C-clamps is that they are difficult to view from the ground as to whether or not they are properly secured to the liner and tank.

Because of the inherent problems with the related art, there is a need for a new and improved tank liner clamp system for efficiently securing a tank liner.

### BRIEF SUMMARY OF THE INVENTION

The invention generally relates to a tank liner clamp which includes a clamp unit, a first member and a second member slidably connected to the clamp unit, and a clamping handle having a cam pivotally connected to the clamp unit. The first member includes a biasing member to bias the first member inwardly towards the second member. The clamping handle is pivoted causing the cam to engage and inwardly force the second member towards the first member.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention utilized to secure a tank liner within a containment tank.

FIG. 2 is a rear upper perspective view of the present invention in the release position.

FIG. 3 is a rear upper perspective view of the present invention in the clamping position.

FIG. 4 is a front upper perspective view of the present invention in the release position.

FIG. 5 is a side view of the present invention in the release position.

FIG. 6 is a top view of the present invention.

FIG. 7 is a bottom view of the present invention.

FIG. 8a is a front view of the present invention.

FIG. 8b is a rear view of the present invention.

FIG. 9a is a side view of the present invention positioned above a sidewall of a containment tank with a tank liner overlapping the upper edge of the sidewall.

FIG. 9b is a side view of the present invention positioned about the sidewall of the containment tank and the tank liner in the release position.

FIG. 9c is a side view of the present invention positioned about the sidewall of the containment tank and the tank liner in the clamping position to secure the tank liner to the upper edge of the containment tank.

### DETAILED DESCRIPTION OF THE INVENTION

### A. Overview.

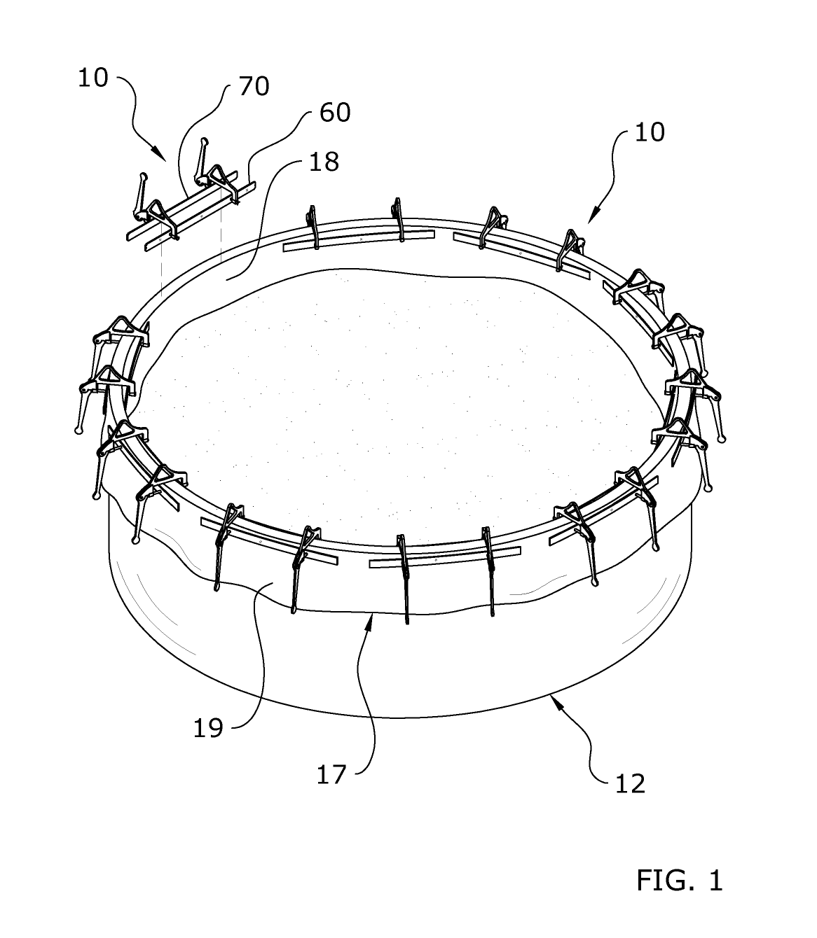

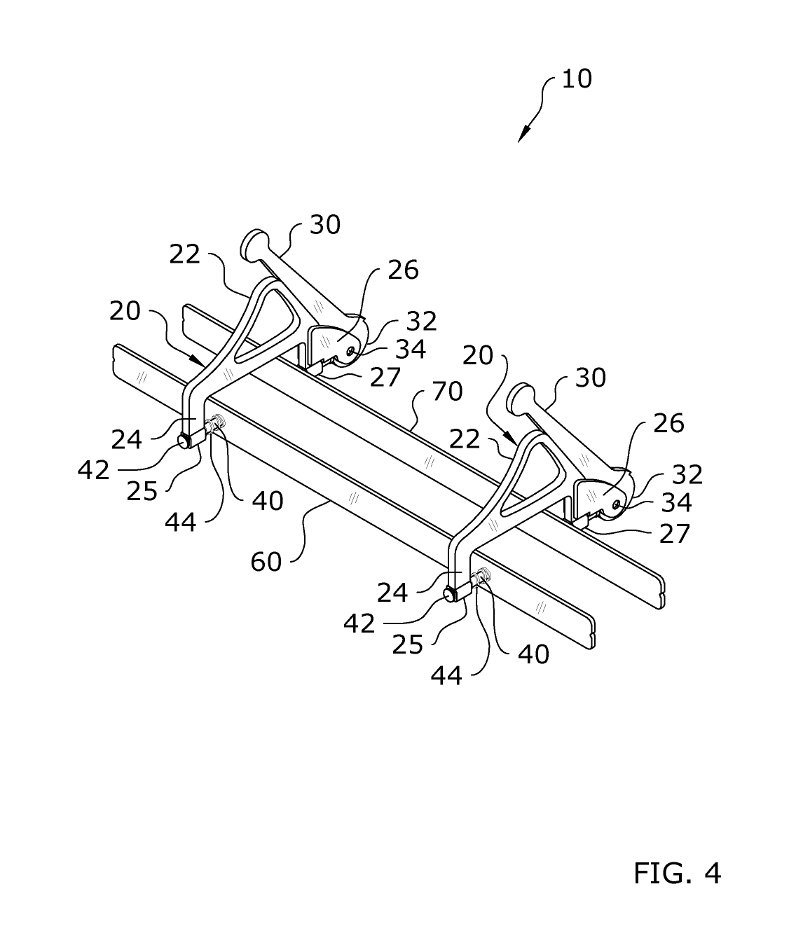

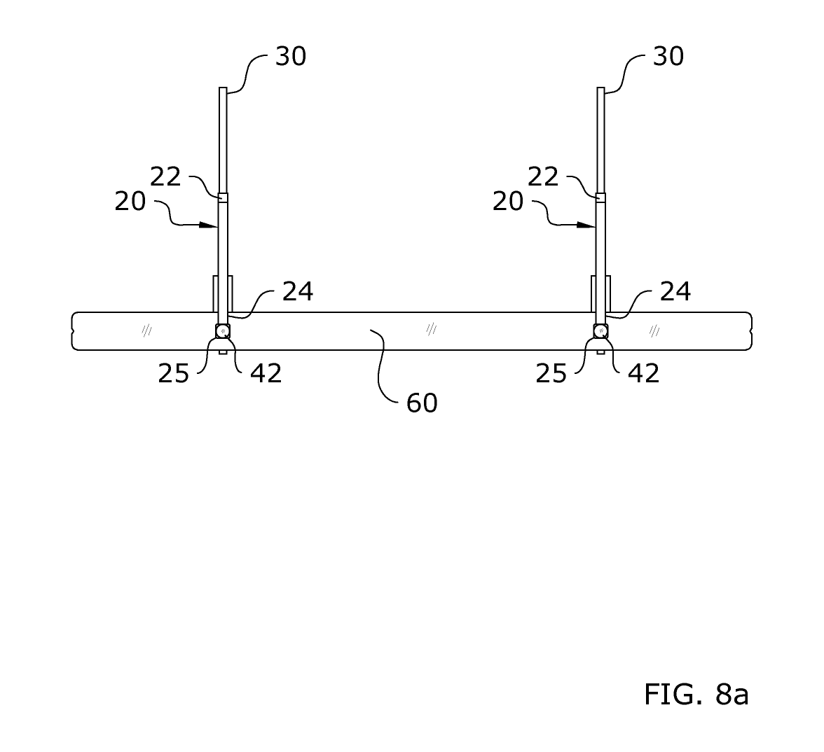

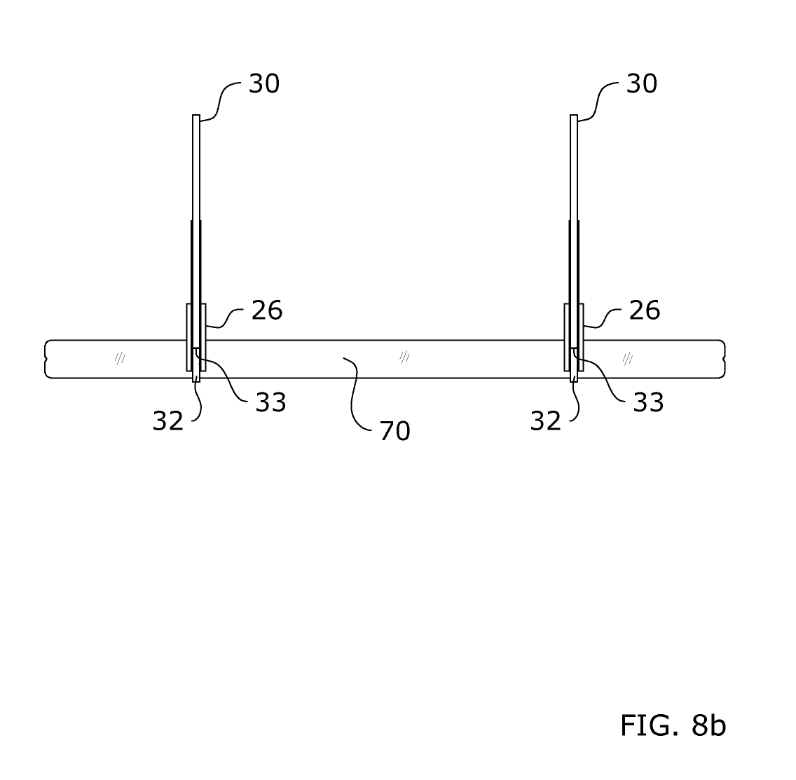

Turning now descriptively to the drawings, in which similar reference characters denote similar elements throughout the several views, FIGS. 1 through 9c illustrate a tank liner clamp system 10, which comprises a clamp unit 20, a first member 60 and a second member 70 slidably connected to the clamp unit 20, and a clamping handle 30 having a cam 32 pivotally connected to the clamp unit 20. The first member 60 includes a biasing member 44 to bias the first member 60 inwardly towards the second member 70. The clamping handle 30 is pivoted causing the cam 32 to engage and inwardly force the second member 70 towards the first member 60.

### B. Clamp Unit.

One or more clamp units 20 are connected to the first member 60 and the second member 70 to force the members 60, 70 towards one another. As shown in FIGS. 1-4 and 6-8b of the drawings, it is preferable to have two clamp units 20 connected to the members 60, 70 at opposite end portions of the members 60, 70. However, three or more clamp units 20 may also be utilized to manipulate the members 60, 70. For the purpose of simplicity, a single clamp unit 20 will be discussed with the understanding that one or more clamp units 20 may be utilized to apply the clamping force upon the members 60, 70.

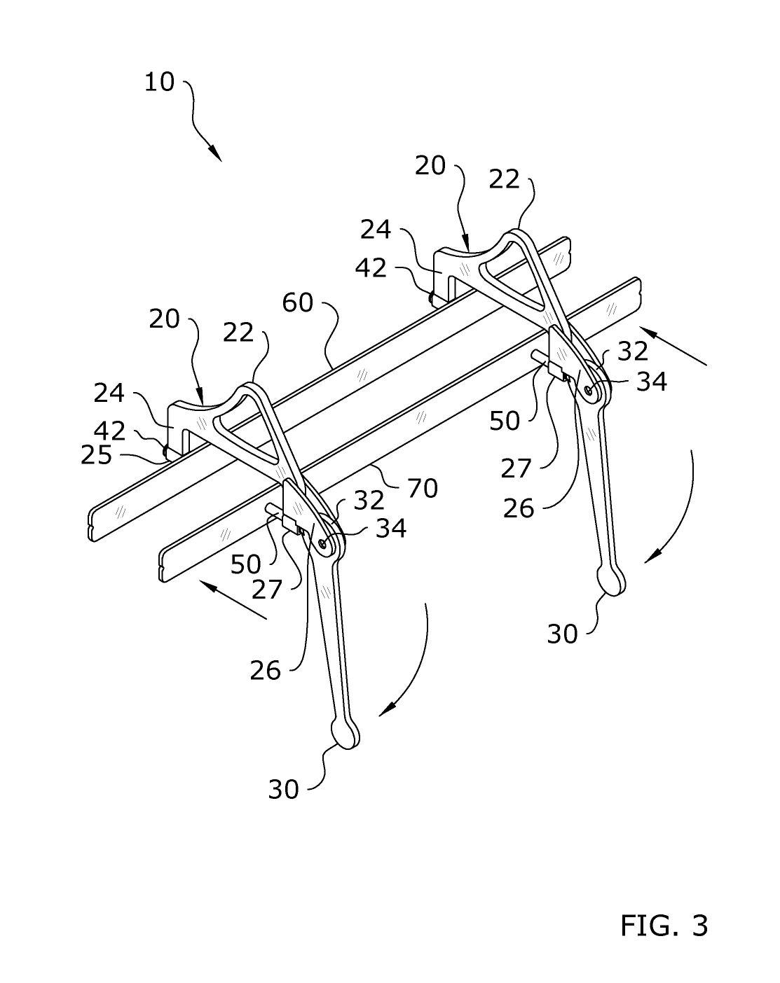

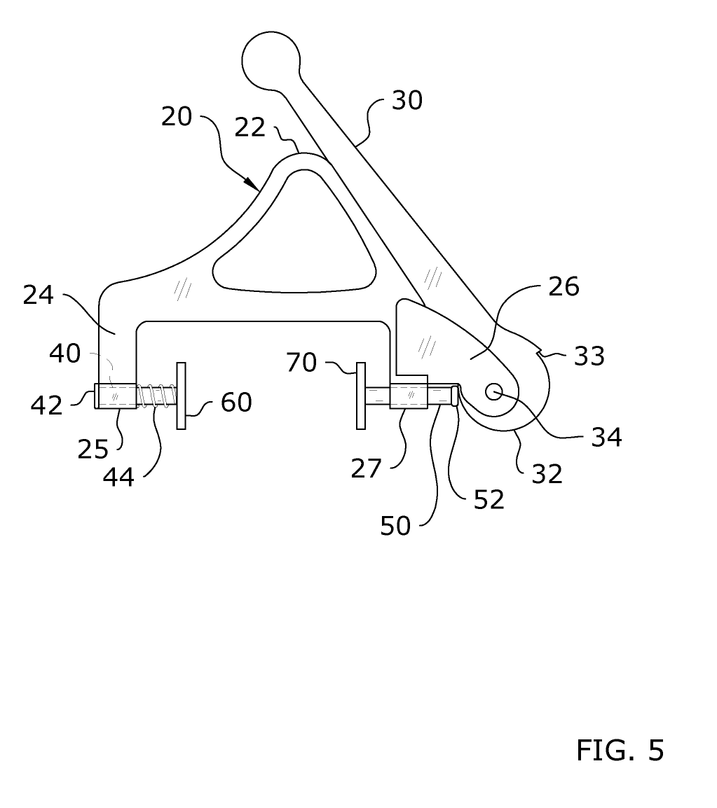

The clamp unit 20 includes a frame having a first end 24 and a second end 26 opposite of the second end 26. The frame of the clamp unit 20 may be constructed of various types of rigid materials such as but not limited to metal. The first end 24 and the second end 26 of the frame of the clamp unit 20 extend downwardly forming an inverted U-shaped structure as best illustrated in FIG. 5 of the drawings. The first end 24 and the second end 26 of the frame of the clamp unit 20 may be integrally formed within the frame or attached to the frame. FIG. 3 illustrates a portion of the second end 26 having a pair of bracket members extending downwardly from the second end 26 of the frame of the clamp unit 20 that pivotally receive the clamping handle 30.

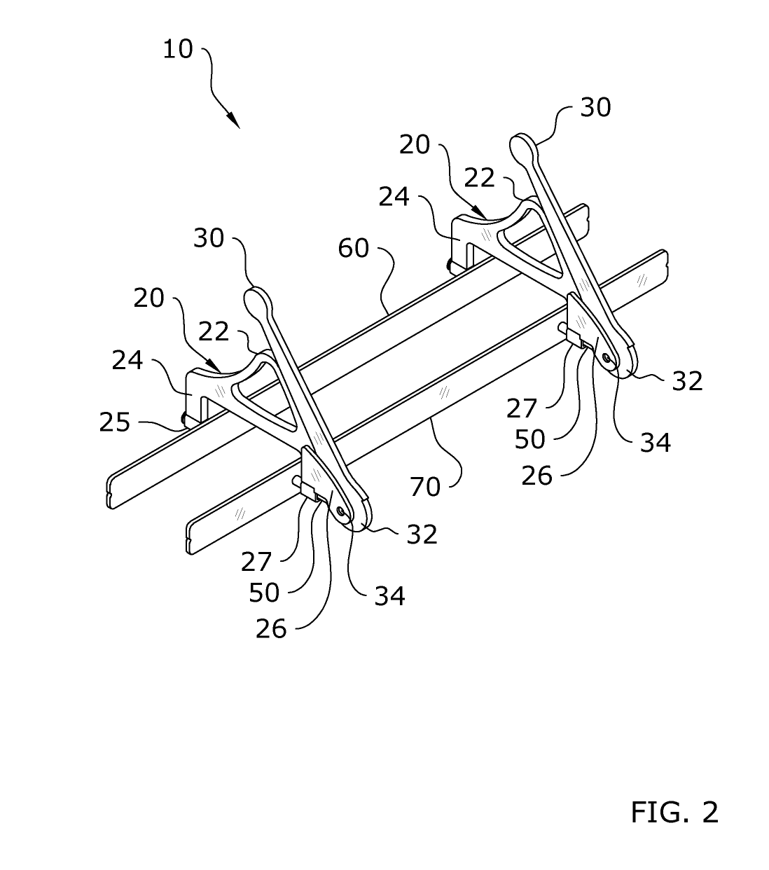

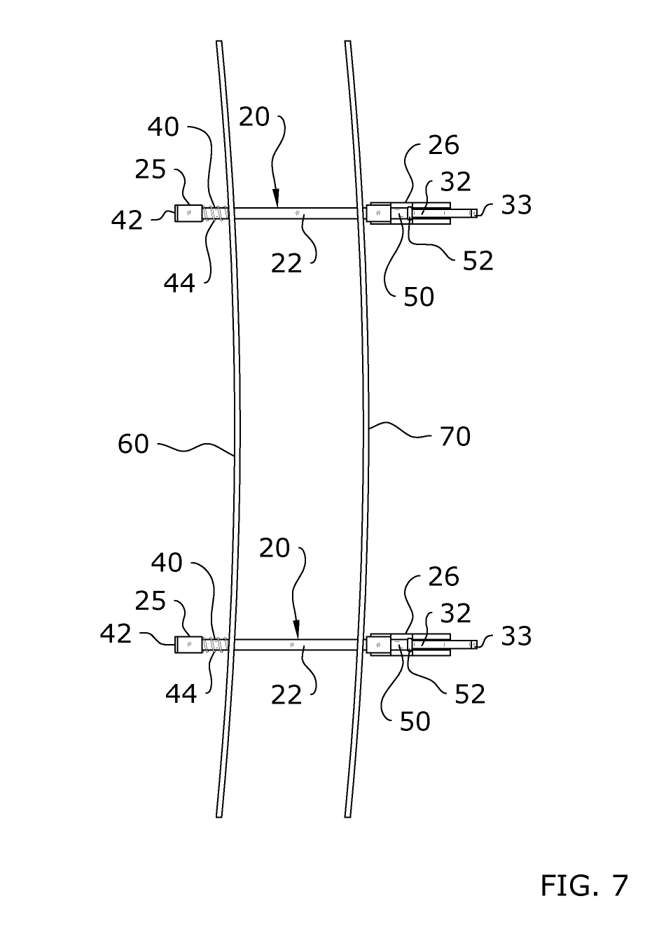

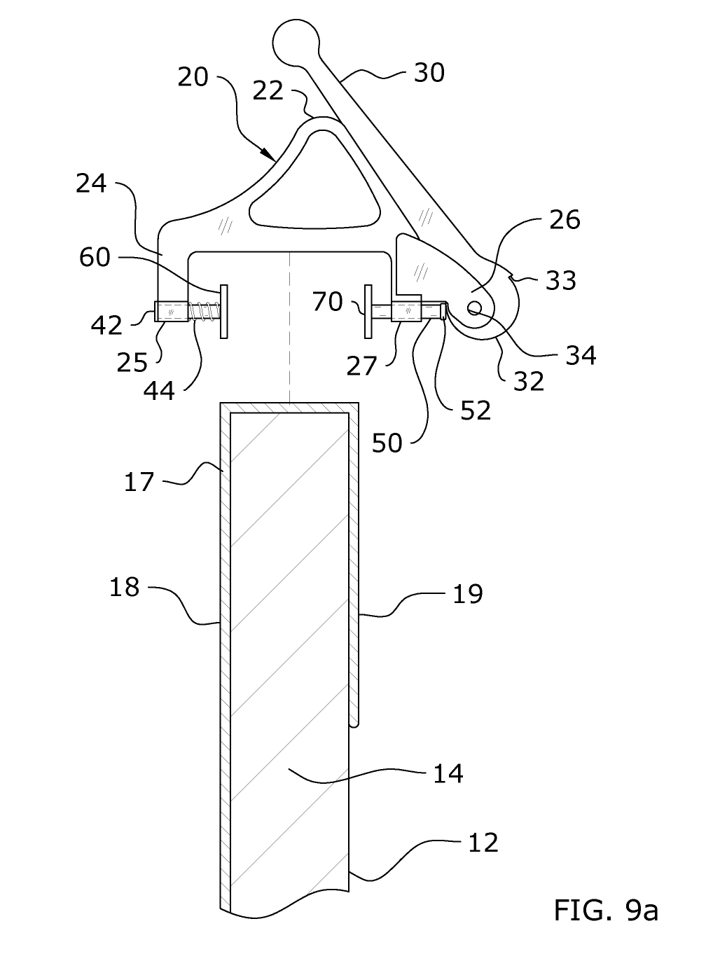

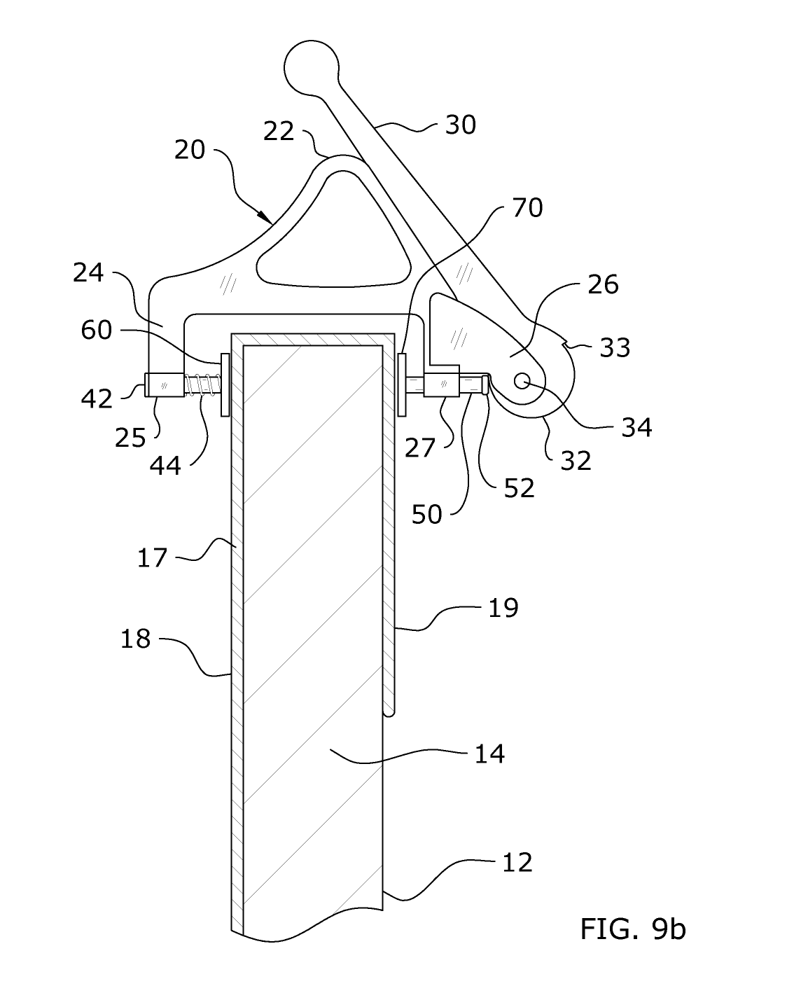

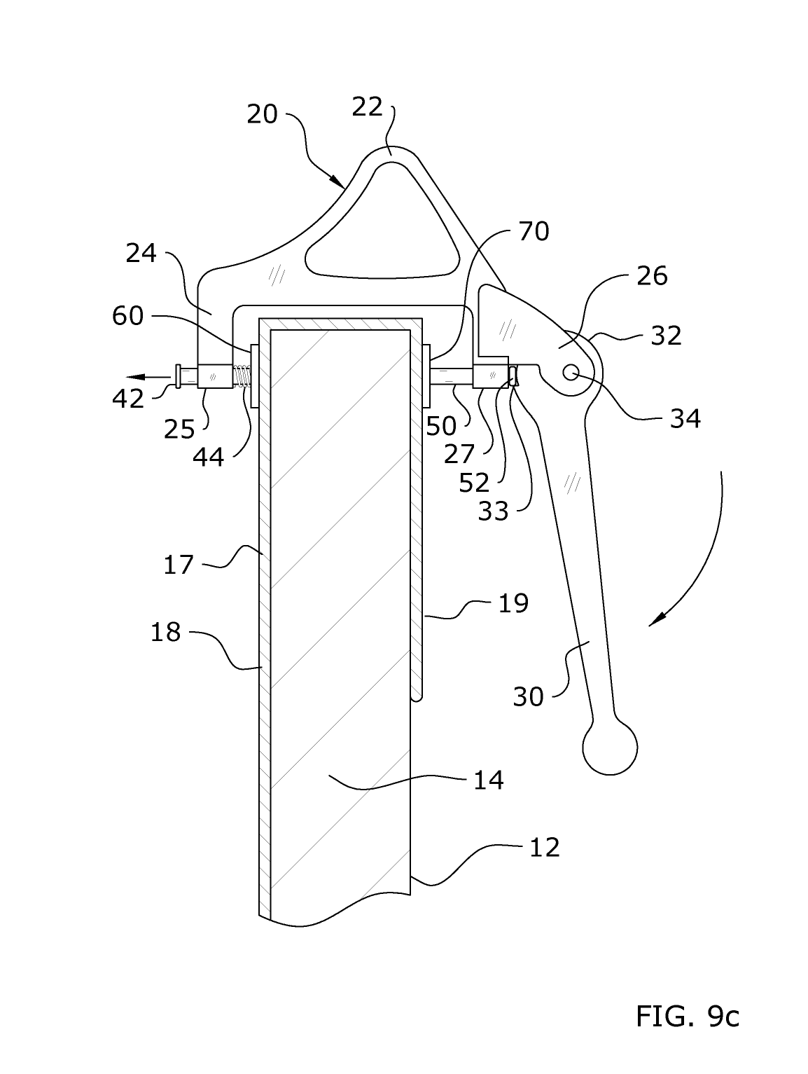

The frame is preferably comprised of an elongated structure sufficient in length to extend beyond the thickness of a sidewall 14 of a containment tank 12 in combination with an inner portion 18 and an outer portion 19 of the tank liner 17 overlapping the upper edge of the sidewall 14 as best illustrated in FIGS. 9a-9c of the drawings. The frame is further relatively lightweight and constructed of a planar structure as illustrated in FIGS. 2 and 7 of the drawings.

The frame of the clamp unit 20 includes a handle portion 22 that allows a user to lift and position the clamp unit 20 along with the members 60, 70 in a desired location (e.g. for installation, removal or transportation from one site to another site). The handle portion 22 is preferably integrally formed within the frame and extends upwardly from the frame of the clamp unit 20 as best illustrated in FIG. 5 of the drawings. The handle portion 22 has a handle opening that is ergonomic for a user's hand to be inserted into with an inwardly curved portion as further shown in FIG. 5 of the drawings.

The frame of the clamp unit 20 has a substantially horizontal portion that extends between the first end 24 and the second end 26 and preferably has a substantially straight bottom side as shown in FIG. 5 of the drawings. The bottom side of the frame further is positioned above the lower ends of the first end 24 and the second end 26 so that when the clamp unit 20 is positioned upon the upper edge of a sidewall 14 of a containment tank 12 that the frame does not touch the tank liner 17 as best illustrated in FIGS. 9b and 9c of the drawings.

### C. First Member & Second Member

The first member 60 and the second member 70 are both comprised of elongated structures as illustrated in FIGS. 2-4 and 6-8b of the drawings. The members 60, 70 are designed and adapted to fit about the upper perimeter of a sidewall 14 of a containment tank 12 to retain the tank liner 17 as illustrated in FIG. 1 of the drawings.

The members 60, 70 may be curved to various radiuses similar to the radius of the containment tank 12 (e.g. a circular shaped tank as shown in FIG. 1). The first member 60 has a radius of curvature approximately the same as the second member 70.

The members 60, 70 may be comprised of straight configurations for a containment tank 12 having straight walls (e.g. a rectangular shaped tank). The members 60, 70 are further comprised of a semi-flexible material such as metal that allows the clamp units 20 to apply a uniform clamping force to the inner portion 18 and outer portion 19 of the tank liner 17.

The first member 60 and the second member 70 are comprised of elongated flat structures. In particular, the members 60, 70 are preferably comprised of a flat strip of metal (e.g. steel flat bar) as illustrated in FIGS. 1 through 9c of the drawings. The members 60, 70 may have various heights, lengths and thickness as desired. The clamp units 20 may be attached at the distal ends of the members 60, 70 or inwardly from the distal ends of the members 60, 70 a desired distance.

### D. First Member.

The first member 60 is connected to the first end 24 of the clamp unit 20 as illustrated in FIGS. 2 through 7 of the drawings. The first member 60 may be non-movably connected to the first end 24 of the clamp unit 20, however, it is preferable that the first member 60 is movably connected to allow for outward movement when the clamp unit 20 applies a clamping force to the members 60, 70. It is further preferable that the first member 60 is slidably connected to the first end 24 of the clamp unit 20 to allow for the first member 60 to slide inwardly and outwardly with respect to the second member 70.

FIG. 5 illustrates a first shaft 40 connected to the first member 60. The first shaft 40 is preferably slidably connected to the first end 24 of the clamp unit 20 to allow for the first member 60 to slide inwardly towards the second member 70 and outwardly away from the second member 70 during usage. The first shaft 40 may be comprised of a solid or hollow structure. FIG. 5 further illustrates wherein the first end 24 of the clamp unit 20 includes a first guide 25 having a tubular structure with a first passage that slidably receives the first shaft 40. The first shaft 40 slides inwardly and outwardly within the first passage of the first guide 25.

### E. Biasing Member.

A biasing member 44 is preferably connected between the first member 60 and the clamp unit 20 to provide an inward biasing force to the first member 60 with respect to the clamp unit 20. The inward biasing force applied by the biasing member 44 is preferably at least 500 lbs. to ensure a proper securing force applied to the tank liner 17 and the sidewall 14.

The biasing member 44 is preferably comprised of a spring and further preferably comprised of a compression spring positioned between the first member 60 and the first guide 25 of the first end 24 of the clamp unit 20 as illustrated in FIG. 5 of the drawings. The compressing spring is positioned around the first shaft 40 as further shown in FIG. 5 of the drawings. The first shaft 40 includes a first flanged end 42 positioned on a side of the first end 24 opposite of the clamp unit 20 as the compression spring as also shown in FIG. 5. The first flanged end 42 prevents the first shaft 40 from escaping the first guide 25 and limits the inward movement of the first member 60. The first flanged end 42 is larger than the first passage of the first guide 25 to prevent entry of the first flanged end 42 into the first passage.

### F. Second Member.

The second member 70 is movably connected to the second end 26 of the clamp unit 20 to allow for inward and outward movement of the second member 70 as shown in FIGS. 2 through 5 of the drawings. In particular, the second member 70 is preferably slidably connected to the second end 26 of the clamp unit 20. The second member 70 preferably slides along a plane of movement that is parallel to the plane of movement for the first member 60 to prevent any vertical movement of the members 60, 70 with respect to one another as they move inwardly or outwardly with respect to a sidewall 14 of the containment tank 12.

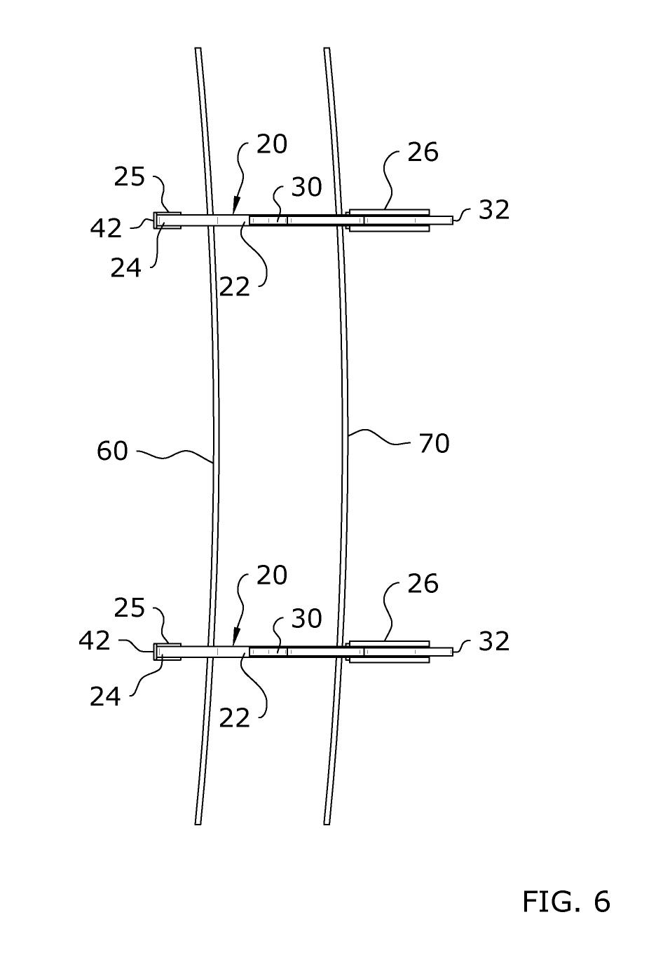

The second member 70 is biased inwardly by the clamping handle 30 manually by the user. The second member 70 is preferably parallel to the first member 60 as illustrated in FIGS. 6 and 7 of the drawings. The first member 60 and the second member 70 conform to the shape and any irregularities of the sidewall 14 of the containment tank 12 when clamped upon the tank liner 17 and sidewall 14.

A second shaft 50 is connected to the second member 70 and extends outwardly to be slidably connected to the second end 26 of the clamp unit 20. The second shaft 50 slidably extends within a second passage of a second guide 27 that extends from the second end 26 of the clamp unit 20. The second guide 27 preferably has a tubular structure that slidably receives the second shaft 50. The first shaft 40 is preferably parallel with respect to the second shaft 50. The second passage of the second guide 27 is preferably concentrically aligned with the first passage of the first guide 25.

The second shaft 50 includes a second flanged end 52 on a side of the second end 26 opposite of the second member 70 as illustrated in FIG. 5 of the drawings. The second flanged end 52 is engaged by the cam 32 of the clamping handle 30 to force the second member 70 inwardly towards the first member 60 during clamping.

### G. Clamping Handle.

The clamping handle 30 is comprised of an elongated structure pivotally connected to the second end 26 of the clamp unit 20 at a pivot point 34 having a clamping position and a release position. The pivot point 34 may be comprised of a pin extending through a pair of bracket members extending from the second end 26 of the clamp unit 20 with the clamping handle 30 pivotally extending between the pair of bracket members as illustrated in FIGS. 2 and 3 of the drawings. The clamping handle 30 preferably pivots about an axis that is transverse with respect to a plane of the frame of the clamp unit 20 such that the clamping handle 30 moves parallel to a plane of said frame of said clamp unit 20.

When in the release position, the clamping handle 30 extends outwardly from the clamp unit 20 at an upward angle and preferably is stopped by the handle portion 22 of the clamp unit 20 as best illustrated in FIGS. 5 and 9a of the drawings. When in the clamping position, the clamping handle 30 extends outwardly from the clamp unit 20 at a downward angle and preferably is stopped from rotating further by the stopper portion 33 extending outwardly from the cam 32 as shown in FIG. 9c of the drawings. The downward angle of the clamping handle 30 ensures that the clamping force applied by the clamp unit 20 is not reduced or that the clamp unit 20 otherwise becomes loosened.

The clamping handle 30 is preferably comprised of a length of rigid material such as metal having a weight and a length sufficient to apply a desired level of torque upon the cam 32 to ensure that the clamping handle 30 is not able to be elevated once in the clamping position. The clamping handle 30 further is sufficient in length (e.g. greater than one foot) to allow for a user to manually move the clamping handle 30 after an extended period of use upon a containment tank 12 even if the cam 32 and/or pivot point 34 become rusted or otherwise contaminated. The distal end of the clamping handle 30 is preferably broader to apply additional weight and torque to retain the clamping handle 30 in the clamping position as illustrated in FIG. 9c of the drawings.

The clamping handle 30 includes a cam 32 positioned upon the inner portion 18 of the clamping handle 30 as best illustrated in FIG. 5 of the drawings. The cam 32 preferably rotates about the pivot point 34 as further shown in FIGS. 9b and 9c of the drawings. The cam 32 is further preferably integrally formed within the clamping handle 30 so that the clamping handle 30 and the cam 32 are a single structure without attachment.

The cam 32 is adapted to force the second member 70 inwardly towards the first member 60 when the clamping handle 30 is in the clamping position. In particular, the radius of the outer surface of the cam 32 that engages the outer end of the second shaft 50 of the second member 70 increases as the clamping handle 30 is pivoted from the release position (see FIG. 9b) to the clamping position (see FIG. 9c). The clamping handle 30 preferably includes a stopper portion 33 adjacent to the cam 32 to limit the movement of the clamping handle 30 so the clamping handle 30 does not extend completely vertical since a vertical position of the clamping handle 30 could result in loosening of the second member 70. In particular, it is preferable that the clamping handle 30 extend at an angle outwardly and downwardly away from a vertical axis at least 5 degrees thereby using the weight and leverage of the clamping handle 30 to maintain the clamping position as illustrated in FIG. 9c of the drawings.

### H. Operation of Preferred Embodiment.

In use, the user positions a tank liner 17 within the interior of a sidewall 14 of a containment tank 12 and extends the outer portion 19 of the tank liner 17 over the upper edge of the sidewall 14 as shown in FIG. 1 of the drawings. The user then positions a unit of the present invention (in the release position) so that the members 60, 70 are aligned above the inner portion 18 and outer portion 19 of the tank liner 17 overlapping the upper edge of the sidewall 14 as illustrated in FIG. 9a of the drawings.

The user then lowers the unit of the present invention upon the upper edge of the sidewall 14 with the first member 60 near the inner portion 18 of the tank liner 17 and the second member 70 near the outer portion 19 of the tank liner 17 as shown in FIG. 9b of the drawings. The user then manually applies force with their hands or via a tool causing the clamping handle 30 to pivot downwardly from the release position to the clamping position.

As the clamping handle 30 is pivoted downwardly, the cam 32 forces the second shaft 50 inwardly thereby causing the second member 70 to extend inwardly. As the second member 70 extends inwardly and engages the outer portion 19 of the tank liner 17, the first end 24 of the clamp unit 20 is drawn inwardly thereby causing the first member 60 to engage the inner portion 18 of the tank liner 17. As the first member 60 engages the inner portion 18 of the tank liner 17, the first shaft 40 slides outwardly within the first guide 25 with the biasing member 44 applying a counter biasing force to the first member 60 as shown in FIG. 9c of the drawings. The clamping handle 30 is lowered until extending at an outward angle and limited from further movement by the stopper portion 33 as shown in FIG. 9c of the drawings.

When the clamping handle 30 is in the clamping position, the biasing member 44 applies a significant inward force to the first member 60 thereby ensuring a relatively constant clamping force applied to the tank liner 17 at all times during usage regardless of temperature or compression of the tank liner 17 over time. For additional clamp units 20 connected to the members 60, 70, the user repeats the above process or may perform the process simultaneously. The user then continues to the next unit of the present invention until the entire perimeter of the containment tank 12 has the tank liner 17 secured by the present invention as illustrated in FIG. 1 of the drawings. The containment tank 12 may then be filled with the desired liquid such as water or chemicals.

Once the containment tank 12 is no longer needed at the location, the above process is simply reversed. The user manually lifts the clamping handle 30 to the release position which removes the clamping force applied to the tank liner 17 by the members 60, 70. The user then lifts the clamping unit upwardly and removes the same. This process is repeated for each of the clamping units and then the tank liner 17 may be removed with the containment tank 12 dismantled for installation at a different job site.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A clamp for securing a tank liner, comprising:
a clamp unit, wherein said clamp unit includes a frame having a first end and a second end opposite of said second end;
a first member connected to said first end of said clamp unit;
a second member slidably connected to said second end of said clamp unit; and
a clamping handle pivotally connected to said second end of said clamp unit at a pivot point having a clamping position and a release position, wherein said clamping handle includes a cam and wherein said cam is adapted to force said second member inwardly towards said first member when said clamping handle is in said clamping position.

2. The clamp of claim 1, wherein said first member is slidably connected to said first end of said clamp unit.

3. The clamp of claim 2, including a biasing member connected between said first member and said clamp unit.

4. The clamp of claim 3, wherein said biasing member is comprised of a spring.

5. The clamp of claim 4, wherein said biasing member is comprised of a compression spring positioned between said first member and said first end of said clamp unit, wherein said compression spring applies an inward force to said first member.

6. The clamp of claim 5, including a first shaft connected to said first member, wherein said first shaft is slidably connected to said first end of said clamp unit.

7. The clamp of claim 6, wherein said compressing spring is positioned around said first shaft.

8. The clamp of claim 6, wherein said first shaft includes a first flanged end, wherein said first flanged end is positioned on a side of said first end opposite of said clamp unit as said compression spring.

9. The clamp of claim 6, including a second shaft connected to said second member, wherein said second shaft is slidably connected to said second end of said clamp unit.

10. The clamp of claim 9, wherein said first end includes a first guide having a tubular structure that slidably receives said first shaft and wherein said second end includes a second guide having a tubular structure that slidably receives said second shaft.

11. The clamp of claim 9, wherein said first shaft is parallel with respect to said second shaft.

12. The clamp of claim 9, wherein said second shaft includes a second flanged end on a side of said second end opposite of said second member.

13. The clamp of claim 12, wherein said second flanged end is engaged by said cam of said clamping handle.

12. The clamp of claim 1, wherein said first member has a radius of curvature approximately the same as said second member.

13. The clamp of claim 1, wherein said first member and said second member are comprised of elongated flat structures.

14. The clamp of claim 1, wherein said frame of said clamp unit includes a handle portion.

15. The clamp of claim 1, wherein said clamping handle includes a stopper portion adjacent to said cam.

16. The clamp of claim 1, wherein said cam rotates about said pivot point.

17. The clamp of claim 1, wherein said clamping handle is comprised of an elongated structure.

18. The clamp of claim 1, wherein said clamping handle extends outwardly from said clamp unit at a downward angle when in said clamping position.

19. The clamp of claim 18, wherein said clamping handle extends outwardly from said clamp unit at an upward angle when in said release position.

20. The clamp of claim 1, wherein said cam is integrally formed within said clamping handle.
